(19) United States
(12) Patent Application Publication
(10) Pub. No.: US 2026/0034475 A1
(43) Pub. Date: Feb. 5, 2026

(54) INTERACTIVE BOOK

(71) Applicant: Portal Adventures Publishing LLC, Albany, OR (US)

(72) Inventor: Suzanne Valentine, Albany, OR (US)

(21) Appl. No.: 19/278,782

(22) Filed: Jul. 24, 2025

Related U.S. Application Data
(60) Provisional application No. 63/679,092, filed on Aug. 3, 2024.

(51) Int. Cl. A63H 33/38; B42D 1/00

(52) U.S. Cl. CPC A63H 33/38; B42D 1/008

(57) ABSTRACT

Interactive book for telling a story and comprising a plurality of integrated see-through clamshell pages, each divided by a divider portion defining a portal, and further comprising a top cover, a rear cover, and a binding mechanism, the pages preferably comprising mat or foam core boards with cutouts to display parts of the clamshells, and the clamshells being oriented with respect to these boards, featuring extended edges and fastening members to secure positioning, the book further comprising a plurality of interactive elements within the transparent clamshells, some of which elements are magnetized, for allowing users to move elements with a magnetic member through the portal, without directly contacting the element and as the story progresses, the book facilitating a dynamic storytelling experience, inviting users to engage with the narrative as prompted by the story's guidance and through physical interaction with the story elements.

### CONTINUITY AND CLAIM OF PRIORITY

This is an original U.S. non-provisional patent application claiming the benefit and priority of a co-pending original U.S. Provisional Patent Application Ser. No. 63/679,092 filed on Aug. 3, 2025.

### FIELD

The invention relates to an apparatus and methods for interactive storytelling, and more particularly to an interactive book, and associated methods of storytelling, for allowing users to play and learn, without necessarily being able to read, by playing with a plurality of elements relating to a story of the interactive book.

### BACKGROUND

Both adults and children enjoy engaging with toys, games, and books. Toys and games promote physical development, problem-solving skills, and creativity. Additionally, books also offer a gateway to imagination, learning, knowledge, and storytelling. Books serve multiple purposes, such as reading, and they can be interactive, encouraging readers to participate in the story through prompts, questions, or activities. Books can also be educational, imparting knowledge and concepts in an engaging manner.

Interactive books have offered storytelling and “transport of readers to different worlds,” introducing the readers to new characters, and weaving captivating narratives. Often, a story is unfolded across multiple pages of a book that keeps readers engaged and eager to turn to the next page. Interactive elements would enhance the storytelling experience, adding layers of engagement and participation. Such elements can range from simple questions and prompts to elaborate pop-ups, sound effects, or tactile experiences.

Many interactive books have included manipulative or moveable elements relating to the story of the book. However, such elements have been difficult to move with hands, which has disrupted storytelling. Operational mechanisms, such as magnets, handles, springs, and more, have not been provided in current books for manipulating story elements through portals within the pages of the books. In some interactive books, interactive elements have been isolated to specific pages, limiting their impact on the overall storytelling experience. This has also made it difficult for readers to connect the elements to the broader narrative and has limited engagement with the story relating to the book. The lack of continuity between interactive elements across pages has restricted the storytelling potential, has limited learning potential, and has limited the user's ability to fully immerse themselves in the experience.

In some prior books, story elements have been removable from the book. Removable story elements have posed a risk of being lost, misplaced, or have become otherwise inaccessible. Such loss has disrupted users' experiences and has limited the books' longevity. Further, such removable elements have not maintained the integrity of a given book's structure. Thus, it is desirable to obtain books with durable and secure elements that are not so readily lost, ensuring that users can enjoy the full interactive experience without the worry of losing essential components.

Many people use interactive e-books. While e-books offer convenience and access to a vast library of content, e-books have lacked the tactile and sensory experience that physical books have provided. The absence of physical interaction can diminish the immersive nature of storytelling and limit sensory engagement for both young children and adults. Additionally, many believe that excessive screen time has negative consequences for children's development and well-being.

Current interactive books lack an opening/portal through different pages of interactive books for allowing story elements from one side of the page to be moved to the other side of the page. The absence of openings or portals between pages in interactive books restricts the potential for seamless storytelling and interactive experiences. Creating portals that allow elements of a story, such as for example little plastic, or magnetic, figurines, allowing users to move them from one page to another, would enhance the flow of the story, deepen user engagement, and elevate the overall interactive experience.

As such, there remains a need in the art for an interactive book which enhances the interactive storytelling process while allowing story elements to move from one side of a page of the book to an opposite side of the page. Similarly, there also remains a need in the art for an interactive book which will allow people to manipulate the story elements easily using an operational mechanism such as a magnetic wand or stylus. In addition, an interactive book that helps users in maintaining structural integrity of the book while flipping pages of the book and manipulating story elements would be desirable.

### SUMMARY

The present invention addresses various problems of current interactive books. In response to the failure of prior art interactive toys and books to allow at least one story element relating to a story of the book to move from one side of a page of a book to an opposite side of the page, without affecting structural integrity of the book. In accordance with one or more aspects of the present disclosure, an interactive book for storytelling by moving an element relating to a story of the book between opposite sides of a page through a portal in the page, is disclosed. Embodiments of the present disclosure provide a book having enclosed variously magnetized elements enclosed within divided clamshell-type pages (i.e., preferably comprising a bubble-type, mated, clamshell-type construction), wherein the elements are capable of passing from one side of a given divided page to the other side of the divided page through a portal in the page and within the clamshell, as called for by a related story and while remaining retained in a clamshell, or mated-enclosed-clamshell-type construction, of each page. In addition, embodiments of the present disclosure also provide an interactive storytelling method using the interactive book.

An embodiment of the present disclosure comprises an interactive book adapted for interactive storytelling. The interactive book comprises a plurality of pages, each page comprising a see-through clamshell (e.g., preferably comprised of mated clamshell halves forming a bubble-like enclosure), each clamshell having a clamshell wall or viewing panel, and preferably top and bottom clamshell viewing panels, the book further preferably comprising a top cover, a rear cover, and a binding mechanism to hold the plurality of pages. A divider portion defines a portal and thus partially divides each clamshell into two halves (e.g., with the divider page being fixed between the two clamshell halves). At least one element relating to a story of the interactive book is adapted to move within the clamshells through the portal from one side of the divider portion to the opposite side of the divider portion, in relation to the story.

Each page of the interactive book may comprise one or more stacked thicknesses of mat board (or matboard), for example made from dense cardboard which may be manufactured from wood pulp or cotton fibers, and which may then optionally be treated with chemicals to improve their durability and strength, such as example may be comprised of a typical art framing-type mat board, and such as for example may be obtained from an art framing supplier, which are adhered to each other. Alternatively, each page may comprise one or more stacked thicknesses of foam core or wood board. Further, each mat board, foam core board, or wooden board, has a central cut portion which is preferably circular but can be of any geometric shape, wherein each of the boards of a page has concentrically aligned cuts therein so as to form preferably cylindrical portions when stacked. The central cut portion comprised of the stacked, or sandwiched, mat boards, foam core boards, or wood boards, is adapted to reveal a viewable portion of the clamshell through the clamshell wall or viewing panel of each page of the interactive book and helps orient story elements relative to the page mat boards or foam core boards. Each clamshell is transparent, has extended edges, and is adapted to enclose at least one, preferably magnetized, element within a portion of the clamshell and the divider portion. The divider portion, for example, may be comprised of carboard, and is used to allow a user to interact with the at least one magnetized element through a portal in the divider portion with a magnetic member, such as a handheld magnetic wand, without directly contacting the at least one magnetized element. The magnetic member helps move the at least one magnetized element within the clamshell and through the portal in relation to the story.

The interactive book may comprise glue or adhesive for fixing of placement of orientation of the clamshell by adhering the extended edges of each clamshell with the mat board with which the extended edges of the clamshell overlap, adhering on one side of the extended edges to keep the clamshell within a cut out portion of the mat board, and adhering on another, opposite, side of the extended edges to adhere the clamshell to each divider portal page. Alternatively, there may be provided an optional fastening member, which helps in orienting the clamshell in a fixed manner relative to the foam core boards, mat boards, or wood boards, of the page, to help, together with gluing, in retaining of each clamshell within its respective page. But it will be appreciated by those skilled in the art that this relative fixing of placement of clamshells may also be achieved exclusively by glueing of the extended edges of each clamshell member to the mat boards, foam core boards, or wood boards, comprising the pages. The optional alternative fastening member may also comprise a plurality of optional spike members which are adapted for piercing partially into the boards (e.g., a foam core board) to orient the clamshell relative to the page foam core boards. The clamshell member may further comprise first and second clamshell portions, each portion preferably having extended edges, and wherein a plurality of the extended edges may further alternatively, or optionally, comprise integrated snap members for holding the first and second clamshell portions together. The spike members may also be integrated into the plurality of extended edges. Further, it will be appreciated that a circular (or other geometry) viewing box may be constructed in each page, with a divider having a portal therebetween halves of the viewing box, wherein the viewing box may be comprised of walls normal to the viewing surface (e.g., comprised on inner cuts on mat, foam core, or wooden, boards) and having an integrated viewing panel surface (such as may be made by clear plastic or plexiglass) in order to create the effect of the mated clamshells of a preferred embodiment.

The elements used in the interactive book for storytelling are preferably magnetized and at least one element of the elements can move within the clamshell portion, or mated clamshell portions, and from one side of the divider portion to the opposite side of the divider portion through the portal in the divider portion. The magnetic member is handheld and used for interacting with the at least one magnetized element in relation to the story. A plurality of elements may be employed in each set of mating clamshell portions, and whereas one or more of the elements may be free to pass through the portal in the divider, other elements may be fixed to the divider to enable enhanced storytelling capability.

The interactive storytelling system includes a bound book including a plurality of pages. A transparent clamshell portion is integrated into at least one of the plurality of pages and a divider portion defines a portal and divides the transparent clamshell portion into at least two parts, each of the at least two parts of the clamshell being interaccessible via the portal. At least one element relating to a story of the book is retained with the clamshell portion, wherein the portal is adapted to allow passage of the at least one element by a user responsive to guidance provided by the story of the book. The clamshell portion may comprise a plurality of clamshell portions, and there is preferably at least one clamshell portion per page of the interactive book. The at least one element comprises a plurality of elements and some of the plurality of elements are associated with ones of the plurality of clamshell portions. The at least one element is magnetized to allow interactive manipulation of the at least one element using a magnetic wand responsive to guidance in accordance with different aspects of the story.

The plurality of elements are preferably three-dimensional and variously magnetized, some of the plurality of elements comprising one polarity of magnetization, and in an embodiment others of the plurality of elements comprising another polarity of magnetization, to allow the user to illustrate attractive and repulsive aspects of various characters portrayed by the plurality of elements responsive to guidance provided by the story. It will be appreciated that all of the members, in an embodiment, may be one or the other polarity of magnetization without departing from the scope of the invention as claimed. Further, it will be appreciated that while some elements may be fixed to the clamshell or to the divider, others may be free to move relative thereto, in order to allow pulling away, or attractive attachment of, magnetic elements one to another-in order to facilitate learning about magnetic properties. Further, preferably, a three-dimensional element may be provided to be movable within the clamshell portion, and even through a portal in the dividing portion, and sized such that the element retains its orientation within the clamshell portion and doesn't flip over, all as may be advantageous to the polarity of the element in terms of the story. Thus, where one magnetic orientation of the element may apply as per the story on a first side of a divided portion, a second magnetic orientation of the element may apply as per the story on the second side of the divided portion. Still further, there may be provided a retaining device for holding the book closed during transport, such as may be provided by a hook, a clasp, or an elastic band. Further yet, the front cover of the book may have an enclosed case, or clamshell, portion within which one, or more, representative elements to the story may be enclosed thematically to the story.

In accordance with an aspect of the disclosure, there is provided a method for interactive storytelling using the interactive book of present embodiments. The preferred steps of the method comprise: providing a book comprising a plurality of pages, a plurality of the plurality of pages being further comprised of a transparent clamshell portion defining clamshell parts, a portion of each of the plurality of the plurality of pages including a divider page defining a portal between the clamshell parts. Initiating a story on one of the plurality of the plurality of pages of the book by introducing at least one moveable element within the clamshell portion relating to the story. Sequentially turning pages of the book to progress through the story, and utilizing the portal of each page to move the at least one element between the pages as a storytelling medium. The method also includes manipulating the at least one element through the portal using a magnetic wand and responsive to directions from the story.

In an embodiment, a first spider is provided as the at least one element, and the spider is moved between the pages using the portals relating to a fictional story, wherein the spider has eight legs and an attached boot to one of the legs, the attached boot being removably attached or permanently attached. In this embodiment, the at least one element may also include at least one new, or additional, spider element relating to the story, or re-introducing of the same spider using a separate element, on one or more pages of the book, attaching flies (whether fixed or moveable) relating to the story to the at least one new spider, removing a boot from the first spider (or in an embodiment using different spiders on different pages, one spider with a boot on one page, and another spider without a boot on another page-both representing the same spider of the story), attaching a fly to the spider, and manipulating all the elements relating to the story both through different aspects of the story and allowing return of the elements to respective original positions once storytelling is completed.

Thus, it may be appreciated that some elements, whether spiders, flies, or other elements, may be moveable within the clamshell portion, and through a portal, or not through a portal, whereas other elements may be fixed to the divider portion, or to a clamshell wall, and in this way, and given various states of polarity of the elements, elements may be made to be separable from one another within the clamshell as by pulling on the moveable element with the wand, or they may be moved close to one another so as to be close enough for magnetic attraction as by pushing or pulling on the moveable element with the wand. All of the attraction and separation of elements may be incorporated into the story to enhance the variety of the story.

With this improved interactive book, people can interact and play with a book through an effective storytelling means without compromising structural integrity of the book and while easily maintaining movement of the at least one element relating to a story of the book. The movements of the elements within the clamshell may be provided in such a way that they are intuitive and encourages exploration by the user, which further in-turn, sparks curiosity of the user. Further certain safety measures may be employed, such as by encouraging supervision, or reinforced clamshell designs to prevent breakage, to prevent swallowing small elements by children, and further simple magnets, and not rare-earth magnets, may be employed for safety reasons considering small children.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings.

### BRIEF DESCRIPTIONS OF DRAWINGS

FIG. 1 shows a close perspective view of an interactive book having a plurality of pages and a binding mechanism in accordance with one or more aspects of the disclosure.

FIG. 2A shows a top view of a cover page of the interactive book, showing a magnetized element and a magnetic wand, in accordance with one or more aspects of the disclosure.

FIG. 2B shows a top view of an alternative cover page of the interactive book, without a portal on the cover page, showing a magnetized element, and an alternative magnetic wand for smaller hands, in accordance with one or more aspects of the disclosure.

FIG. 3 shows a top view of a first page and a second page of the interactive book showing different magnetized story elements and a story relating to the book in accordance with one or more aspects of the disclosure.

FIG. 4 shows a top view of a second page and a third page of the interactive book showing next steps of the story by introduction and movement of the magnetized elements in accordance with one or more aspects of the disclosure, and wherein a portal shown on the right in FIG. 3 aligns with a portal shown in FIG. 4, each portal of each side a divider portion of a page preferably aligning with the portal on the other side of the page so as to render the portal as passing entirely through each divider portion.

FIGS. 5 and 6 illustrate top views of next steps of removing of a boot from a spider of the story to catch flies in accordance with one or more aspects of the disclosure, each page thereof, except for the final page, showing a portal through a divider portion as previously described.

FIG. 7 shows a front perspective view of the interactive book in a partially open state to illustrate construction, and an enclosing clasp member for maintaining closure during transport and otherwise, in accordance with one or more aspects of the disclosure.

FIG. 8 shows a top front perspective view of an embodiment of the interactive book, and having a stretchy elastic band portion for maintaining closure, all in accordance with one or more aspects of the disclosure.

FIGS. 9A-9C illustrate a top front perspective view, a top view, and a front view, respectively, of a preferred construction of the book by illustrating specifically in FIG. 9C layers of mat material built up wherein adhesive is used to retain a clamshell of the interactive book fixed in place in accordance with one or more aspects of the disclosure.

FIGS. 10A-10C illustrate a top front perspective view, a top view, and a front view, respectively, of an alternative construction of the book by illustrating spike members for positioning and retaining and snap fasteners used to retain a clamshell of the interactive book fixed in place in accordance with one or more aspects of the disclosure.

### DETAILED DESCRIPTION

Prior art interactive books lack manipulative story elements and a portal within a clamshell of one or more pages of the book for interactive storytelling. Conventional interactive books have provided limited interaction. In response to some limitations of prior art interactive books, there is provided an improved interactive book providing one or more portals and elements, whether magnetized or not, and whether variously magnetized in terms of polarity, or not, adapted for being manipulated by a user to move around within the clamshell portion and/or to pass through the one or more portals.

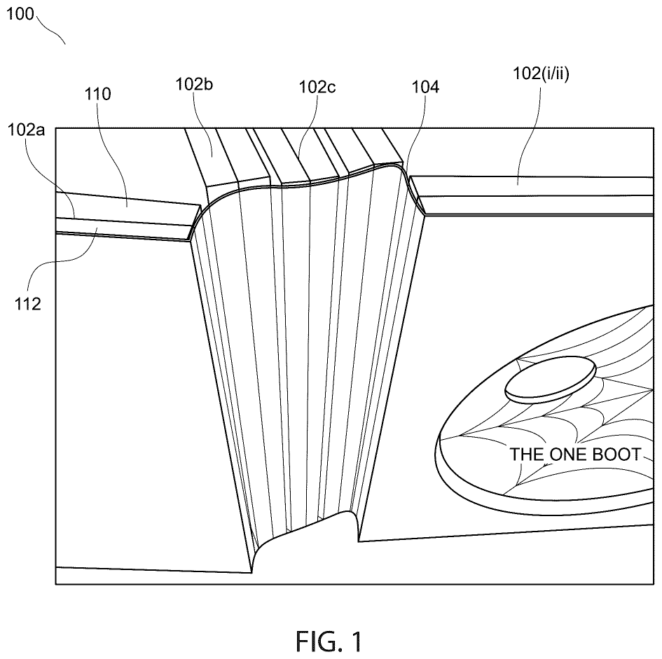

FIG. 1 shows a close view of the interactive book of the present invention, in accordance with one embodiment of the present invention. The interactive book 100 includes a plurality of pages 102a-n(i/ii), wherein the (i/ii) is used to designate a first side of each page (i.e., the divider portion of the page) and a second side of each page (also referred to herein as “102a-n”, or just “102”). The plurality of pages 102a-n are bound by a binding mechanism 104 which holds the pages together. The interactive book 100 is designed for providing interactive storytelling using the plurality of story elements 128 which are preferably magnetic. Thus, one or more story elements 128 are manipulated across the pages 102a-n of the interactive book 100 for storytelling.

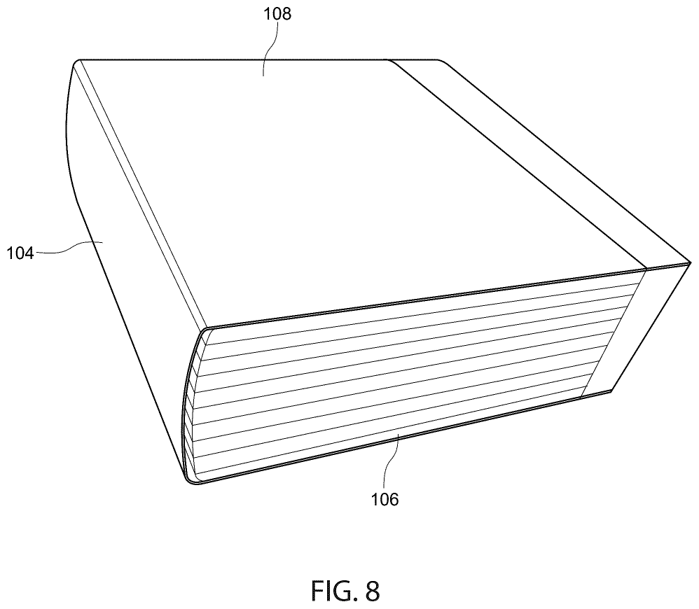

Referring now to FIGS. 1, 7 and 8, the interactive book 100 also includes a top cover 106 and a rear cover 108. The plurality of pages 102a-n are disposed between the top cover 106 and the rear cover 108. The top cover 106 and the rear cover 108 can have any logo or indicia (not shown) disposed thereon for marketing and branding purposes. The top cover 106 and the rear cover 108 are also bound by the binding mechanism 104. Optionally, the top cover 106, and or the bottom cover 108, may have a clamshell portion therein for purposes of holding elements thematic to the story.

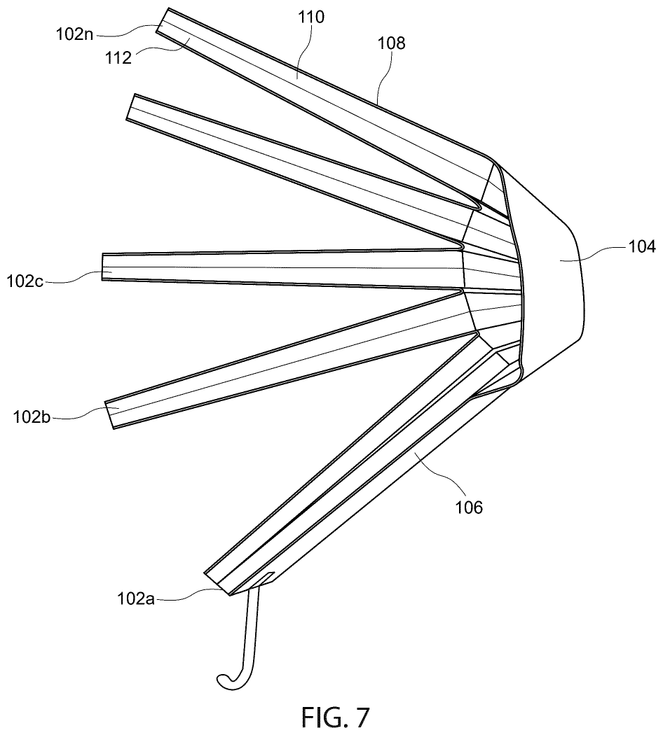

Referring now to FIGS. 1 and 7, each page 102 of the interactive book 100 comprises a sandwich construction of mat boards, a pair of foam core boards, and or wood boards, 110, 112 adhered to each other using a fastening means such as an adhesive. Alternatively, the boards 110, 112 may be permanently integrated to each other. The boards 110, 112 are of substantially the same size and overlap with each other. Further, the boards 110, 112 of each page 102 are durable, sturdy, and can be made in different thickness and sizes.

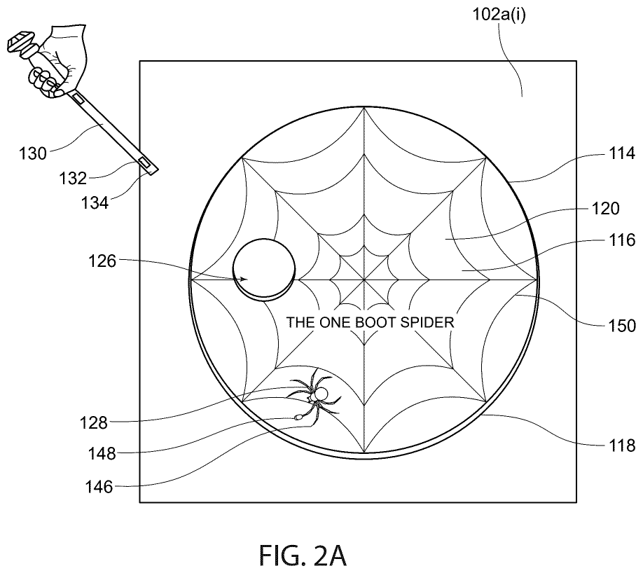

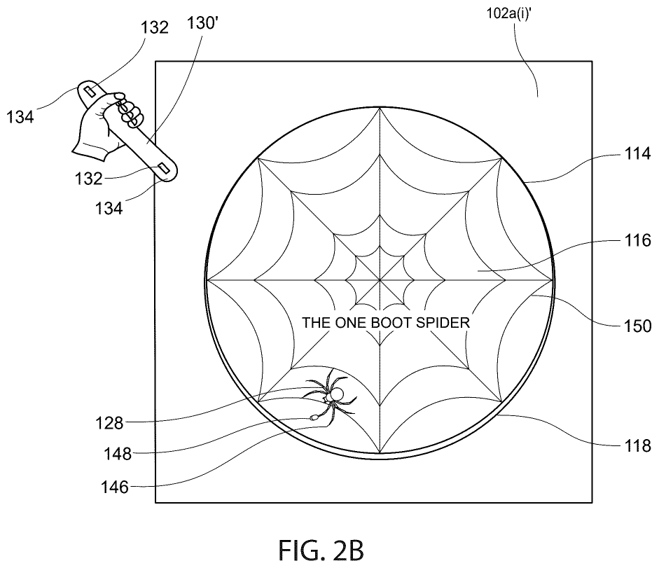

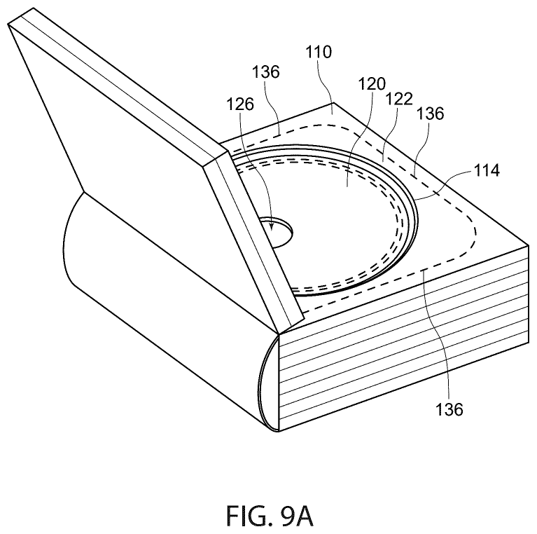

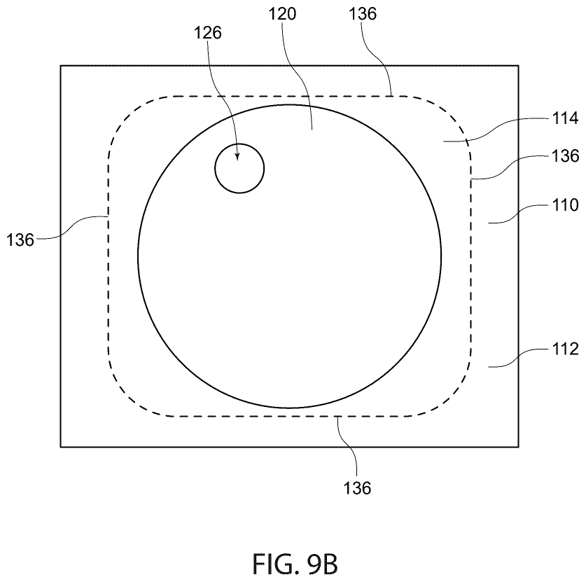

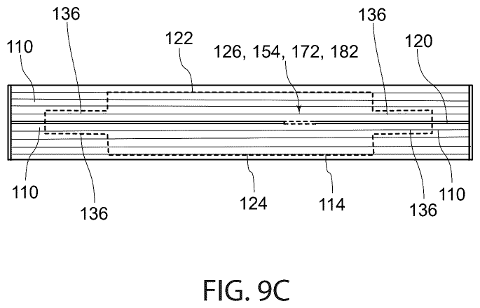

FIG. 2A shows a top perspective view of a page of the interactive book of the present invention in accordance with an embodiment. Each page 102 of the interactive book 100 includes a see-through clamshell 114. The clamshell 114 has a viewable portion 116 which is revealed through a central portion cut out 118 disposed in each board 110, 112 of the page 102. The clamshell 114 includes a divider portion 120 (FIG. 9C) for dividing the clamshell 114 into two clamshell opposite halves 122, 124 (FIG. 9C). The divider portion 120 defines a portal 126 (also designated 154 in FIG. 9C) which is preferably in the form of a small hole or opening in the divider portion 120.

FIG. 2B is similar to FIG. 2A, but it shows an alternative wand 130′ more suitable for use by smaller hands, as having easily manageable accessibility to differently polarized magnets, where as the wand 130 of FIG. 2A has a switchable wand having different polarity magnets at different portions of the wand. Further, there is no portal 126 shown in FIG. 2B, suggesting that the portal may be optional for a cover page, an end page, or one or more pages in-between.

At least one element 128 relating to a story of the interactive book 100 is retained within the clamshell 114 and the portal 126 of FIG. 2A is adapted to allow passage of the element 128 from first half 122 of the clamshell 114 to the opposite, second, half 124 of the clamshell 114 (see also FIGS. 9A-C). Preferably, the element 128 is moved using a user hand-operated manipulative element 130, such as a magnetic wand 130 (or 130′ of FIG. 2B), responsive to guidance in accordance with different aspects of the story relating to the interactive book 100. The user hand-operated manipulative element 130 is handheld and includes a magnet 132 at the distal end 134 thereof to guide the story element 128 within the clamshell 114 and optionally through the portal 126. Alternatively, there may be provided a hand-operated manipulative element 130′ for smaller hands and/or having a magnet 132 at both ends of the hand-operated manipulative element 130′ to guide the story element 128 within the clamshell and optionally through the portal 126. The magnet 132 of the user hand-operated manipulative element 130 may spin within the manipulative element to allow movement of either polarity magnets implemented in the interactive book 100.

Referring to FIGS. 9A-C, the clamshell halves 122, 124 include extended edges 136. One or more of the extended edges 136 are adapted for being glued to the divider portion 120 and to one or more boards 110 to hold the clamshell halves relative to openings in the boards 110.

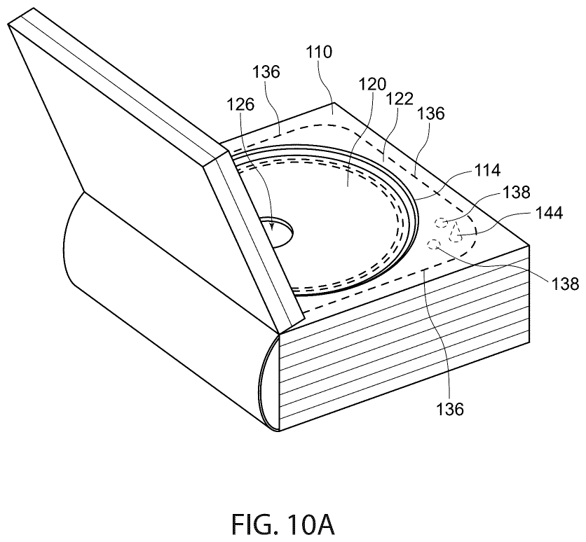

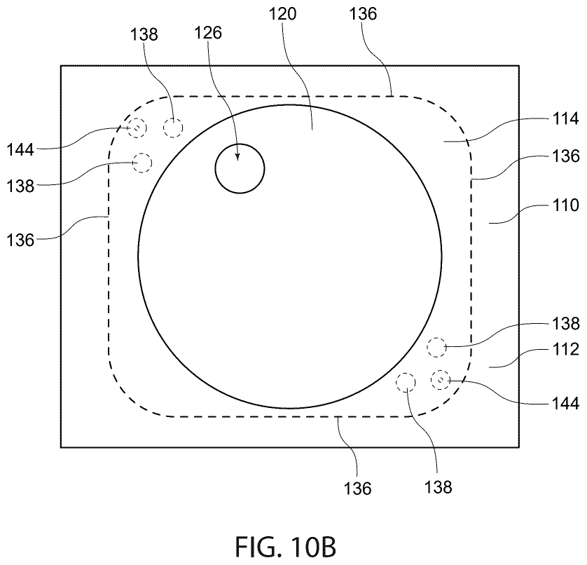

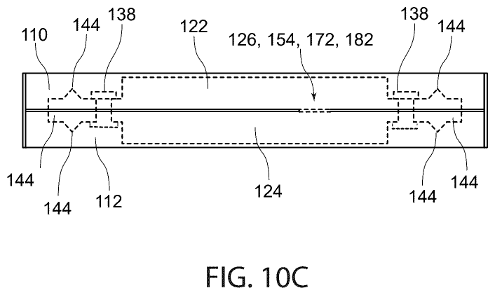

In an alternative embodiment, referring to FIGS. 10A-C, each page board 110 (in this case it is a foam core board) includes one or more fastening members 144 integrated in the clamshell halves 122, 124. The fastening members 144 help in orienting the clamshell 114 (preferably the two portions 122, 124 comprise the entire clamshell 114, and the clamshell may be a sealed integral member instead of comprised of two halves without departing from the scope of the invention as broadly claimed) relative to the page foam core boards 110, 112. In an embodiment, the fastening members are positioning members 144 in the form of pointed spike members 144 adapted for piercing partially into the foam core boards 110, 112 as illustrated in FIG. 10C. A plurality of the extended edges 136 may also include snap members 138. The snap members 138 are adapted for holding the clamshell halves 122, 124 together in this embodiment, whereas glue may be used in the embodiment shown in FIGS. 9A-C.

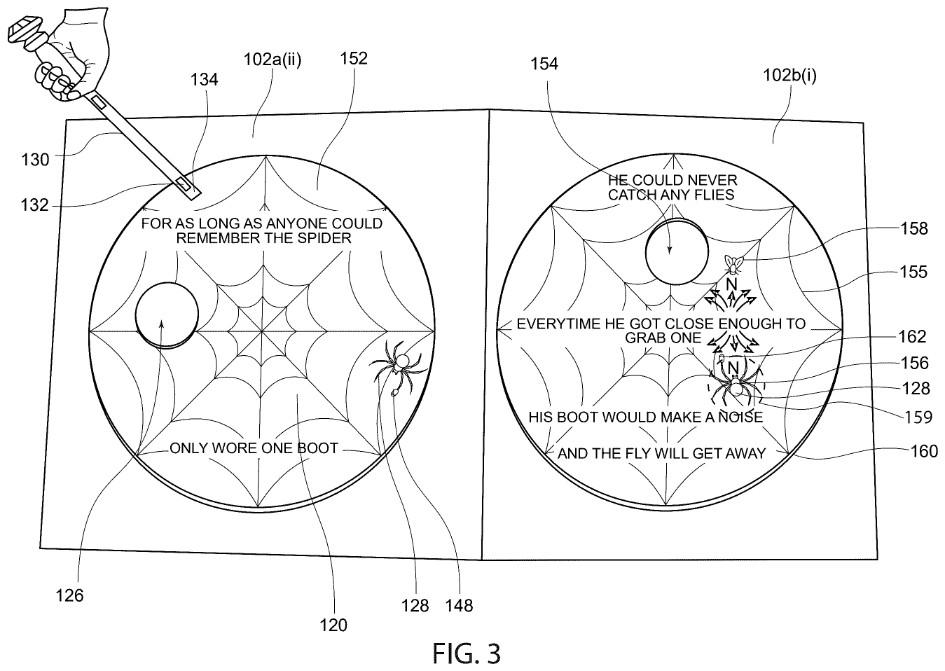

Referring to FIGS. 2A-6, there are shown exemplary pages for an exemplary story relating to the interactive book 100 in accordance with one or more aspects of the disclosure. As illustrated, in FIG. 2A, the story element 128 is in the form of a magnetized spider and is included relating to a story of the book 100. The spider 128 includes eight legs 146 and one of the legs has an attached boot 148. In a preferred embodiment of the story, the boot 148 is indicated as being removably attached to the leg just like any other boot a person or an imaginary being might wear, but in reality on the first page of the story the boot 148 is technically permanently attached to the leg (whereas later on in the story the boot is shown as being removable and having been removed from the spider's leg. Also, in reality, different spiders play the role of the main spider 128 in subsequent pages, except in the case where a portal is provided from one portion of a page, e.g., page 102a (i), to another portion of the same page, e.g., page 102a (ii), in which case the same spider (or element) is allowed to transport between the two portions of the page). The magnetized spider 128 is adapted to be maneuvered along the divider portion 120 using the magnetic wand 130 and to pass through the portal 126 (of FIG. 2A) from the first side 150 to the opposite side 152 (shown in FIG. 3) of the divider portion 120.

As illustrated in FIG. 3, the magnetized element 128 is capable of being moved to the opposite side 152 of the divider portion 120 from the first side 150 of the divider portion 120 of FIG. 2A through the portal 126 of page 102a (i) to page 102a (ii). The boot 148 is still attached to one of the legs 146 of the spider 128. FIG. 3 also illustrates the next page 102b (i), and the page 102b (i) includes another portal 154 in the divider portion 155 and a new magnetized element 156 which functions as the same spider 128 of FIG. 2A. The pages 102a and 102b are separate and sealed separately and independently using a transparent cover. An additional magnetized element 158 in the form of a magnetized fly is present in the clamshell 160 of the page 102b (i). The boot 162 of the element 156 shakes/repels the fly 158 away because of same magnetic polarity of the boot 162 resulting in the magnetized spider 156 not being able in catching the magnetized fly 158. Furthermore, in another embodiment, a magnet 159, for example shown as a dashed circle under a magnetized stationary spider 156 in FIG. 3, may be embedded in the page 102b (i) to simplify repelling or attracting of other magnetized moveable objects. For example, as the user attempts to bring the magnetized fly 158 closer to a stationary spider 156 using the magnetic wand 130, the magnet 159 embedded in the page 102b (i) under the stationary spider will repel the magnetized fly 158.

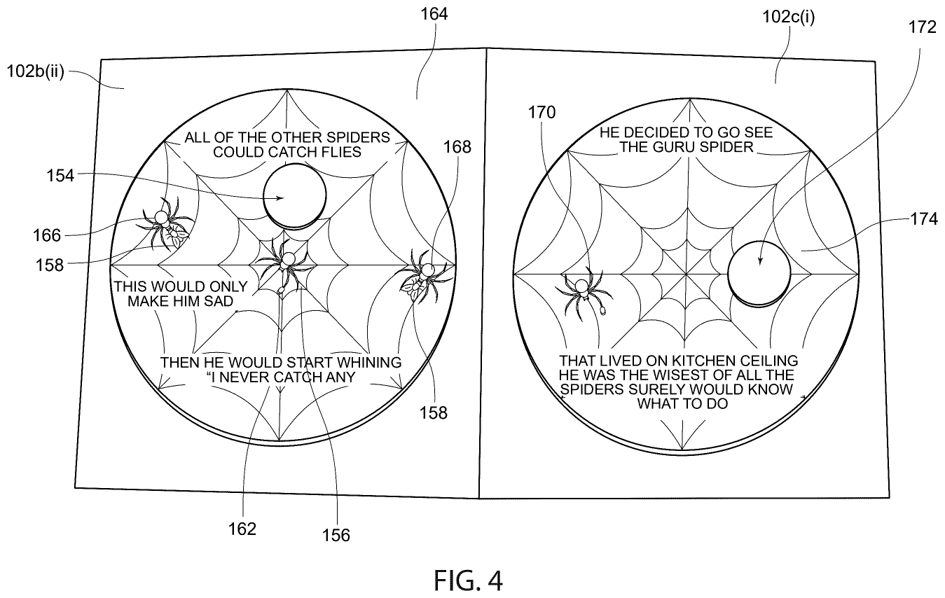

FIG. 4 illustrates the opposite side 164 of the page 102b (i), or in other words page 102b (ii), and additional spiders 166, 168 which can catch the flies 158 as the additional spiders 166, 168 do not contain a boot on any of their legs. The spider 156 (playing as spider 128) moves through the portal 154 and the boot 162 of the spider 156 repels the flies 158. Therefore, the spider 156 does not catch the flies as per the story of the book 100.

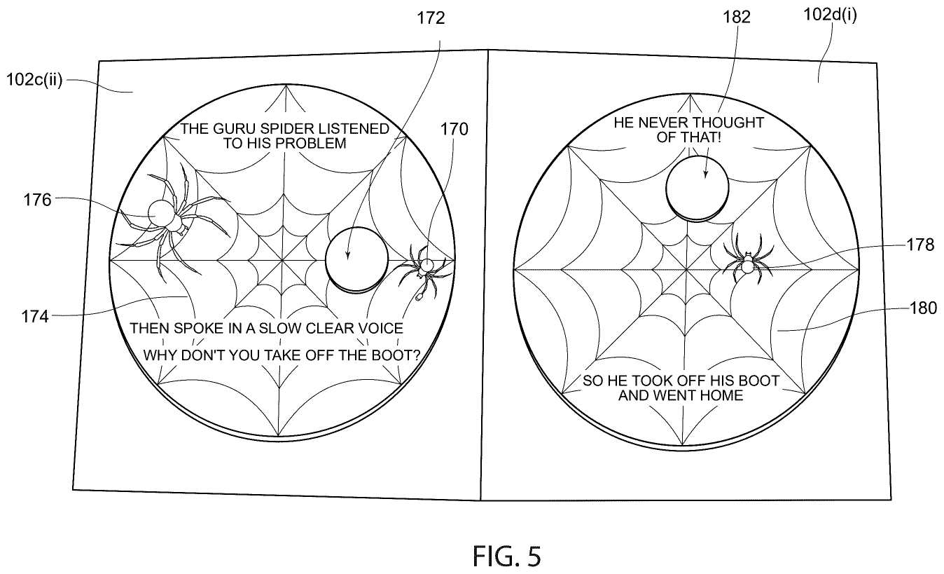

As illustrated, the next page 102c (i) of FIG. 4 introduces spider 170 which is also playing the role of spider 128 (with a boot on) and as per the story relating to the pages of the book 100, it decides to move through the portal 172 defined by the divider portion 174 to see a master or guru spider 176 as illustrated in FIG. 5 on page 102c (ii). It should be noted that the design of the clamshell of each page may be made to accommodate the storyline of the story along the pages of the book 100.

As illustrated in FIG. 5, page 102c (ii), the spider 170 (playing the role of spider 128) moves through the portal 172 to reach the opposite side of the divider portion 174 where the guru spider 176 is introduced. As per the story relating to the book 100, the guru spider 176 advises the spider 170 to take the boot off to be able to catch flies without making too much noise.

On the next page 102d (i) (still of FIG. 5), spider 178 (still playing the role of spider 128) without any boot is introduced indicating the new spider 178 is the spider 170 (128) without any boot as per advice of the guru spider 176. The divider portion 180 of the page 102d (i) has the portal 182 for manipulating the spider 178 to the opposite side of the divider portion 180. Note that pages 100 on either side of a divider portion have concentrically aligned portal holes to allow passage of the element, such as a spider, through to the other side of the divider portion, or page.

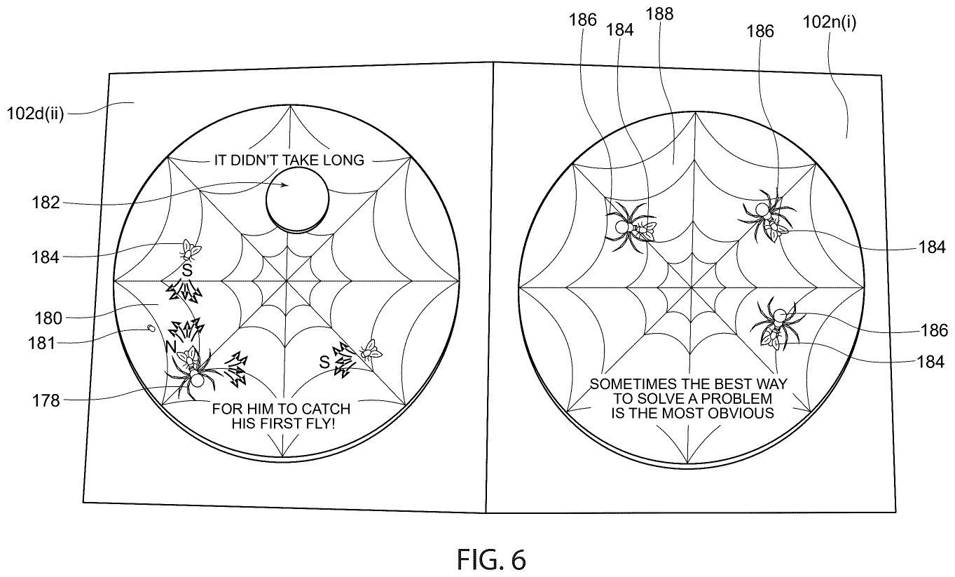

Referring now to FIG. 6, the spider 178 (playing the role of spider 128) without the boot 181 can magnetically attract flies 184 (i.e., because in accordance with the story the spider is able to move without making noise because it is no longer wearing the boot) which are essentially the same as the flies 158. The spider 178 (playing spider 128) can be manipulated using the magnetic wand 130 to catch one or more flies 158 on the divider portion 180 of the clamshell of the page 102d (ii). On the next page 102n (i), the flies 184 can be shaken or moved using the magnetic wand 130, 132 to attract to different spiders 186 with each spider catching a fly. As the page 102n (i) is the last page of the book 100, therefore, the divider portion 188 preferably does not have any portal for movement of an element (e.g., a spider) to the opposite side of the page 102n (ii). In order to be able to separate the flies 184 from the spiders 186 using the magnetic wand 130, the spiders 186 are fixed to the divider portion 188 to allow pulling of the flies away. Once, the story relating to the book 100 is complete, all the magnetized elements are moved back to their original positions, e.g., as by shaking them to their starting locations, or by moving them with the magnetic wand 130, 132 to their starting locations, to reset the book 100.

In the preceding description, numerous details were set forth. It will be apparent, however, to one skilled in the art, that the present invention may be practiced without some of these specific details. Additionally, one of ordinary skill in the art will recognize the inventive principles disclosed are not limited to the embodiments disclosed herein, and that various aspects of the disclosed embodiments can be combined to achieve yet additional embodiments. Thus, for example, it will be appreciated that other types of stories other than just spider/fly related stories may be implemented using similar components of book pages, portals, elements, and magnetic wand (or other manipulating means such as shaking) without departing from the broader aspects of the invention as claimed. In some instances, well-known structures and devices are shown in block diagram form, rather than in detail, in order to avoid obscuring the present invention.

While a preferred embodiment of the present disclosure has been shown and described, it will be apparent to those skilled in the art that many changes and modifications may be made without departing from the claimed subject matter in its broader aspects. For example, it will be appreciated that one of ordinary skill in the art may mix and match the various components of the various embodiments of the claimed subject matter without departing from the true spirit of the claims. The appended claims are therefore intended to cover all such changes and modifications as fall within the true spirit and scope of the invention.

What is claimed is:

1. An interactive book, comprising:
at least one page, each page comprising a see-through clamshell disposed therein;
a divider portion defining a portal and dividing each clamshell; and
at least one element relating to a story of the book, wherein said at least one element is adapted to move through the portal from one side of said divider portion to an opposite side of said divider portion in relation to the story.

2. The book of claim 1, wherein the book comprises a plurality of said pages, and wherein the book further comprises a top cover, a rear cover and a binding mechanism adapted to hold said pages.

3. The book of claim 1, wherein each page further comprises a plurality of mat or foam core boards adhered to each other, each board having a central portion cut out for revealing a viewable portion of the clamshell, and wherein each clamshell orients relative to the page boards.

4. The book of claim 2, further comprising a fastening member, and wherein said clamshell further comprises extended edges with said fastening member integrated therein for orienting said clamshell relative to said page boards.

5. The book of claim 4, wherein said fastening member comprises a plurality of pointed spike members adapted for piercing partially into the boards to orient said clamshell relative to said page boards.

6. The book of claim 1, wherein each said element is magnetized allowing a user to move at least one of each said magnetized element from one side of said divider portion to the opposite side of said divider portion.

7. The book of claim 6, wherein each said page clamshell is transparent to enclose said at least one magnetized element within a portion of said clamshell and said divider portion to allow a user to interact with said at least one magnetized element with a magnetic member, without directly contacting said at least one magnetized element, to help move said at least one magnetized element within said clamshell and through the portal in relation to the story.

8. The book of claim 7, wherein said magnetic member is able to be handheld and used for interacting with said at least one magnetized element in relation to the story.

9. The book of claim 5, wherein each said clamshell member further comprises first and second clamshell portions having extended edges, and wherein a plurality of said extended edges further comprise integrated snap members adapted for holding said first and second clamshell portions together, and wherein said pointed spike members are also integrated into the plurality of extended edges.

10. An interactive storytelling system, comprising:
a bound book including a plurality of pages;
a transparent clamshell portion integrated into at least one of said plurality of pages;
a divider portion defining a portal and dividing said transparent clamshell portion into at least two parts, each of the at least two parts of said clamshell being interaccessible via the portal; and
at least one element relating to a story of the book and retained with the said clamshell portion, wherein the portal is adapted to allow passage of said at least one element by a user responsive to guidance provided by the story of the book.

11. The interactive story-telling system of claim 10, wherein said clamshell portion comprises a plurality of clamshell portions, at least one clamshell portion per page of said book.

12. The interactive story-telling system of claim 11, wherein said at least one element comprises a plurality of elements, some of said plurality of elements being associated with ones of said plurality of clamshell portions.

13. The interactive story-telling system of claim 10, wherein said at least one element is magnetized to allow interactive manipulation said at least one element using a magnetic wand responsive to guidance in accordance with different aspects of the story.

14. The interactive story-telling system of claim 12, wherein said plurality of elements are variously magnetized, some of said plurality of elements comprising one polarity of magnetization, and others of said plurality of elements comprising another polarity of magnetization, to allow the user to illustrate attractive and repulsive aspects of various characters portrayed by said plurality of elements responsive to guidance provided by the story.

15. A method for interactive storytelling, comprising the steps of:
providing a book comprising a plurality of pages, a plurality of said plurality of pages being further comprised of a transparent clamshell portion defining clamshell parts, a portion of each of said plurality of said plurality of pages including a divider page defining a portal between the clamshell parts;
initiating a story on one of said plurality of said plurality of pages of the book by introducing at least one moveable element within the clamshell portion relating to the story;
sequentially turning pages of the book to progress through the story; and utilizing the portal of each page to move said at least one element between the pages as a storytelling medium.

16. The method for interactive storytelling of claim 15, wherein the at least one element is magnetized and further comprising the step of manipulating the at least one element through the portal using a magnetic wand and responsive to directions from the story.

17. The method for interactive storytelling of claim 16, further comprising using a spider as the at least one element, and moving the spider between the pages using the portals relating to the story.

18. The method for interactive storytelling of claim 17, wherein the spider has eight legs and an attached boot to one of the legs, the attached boot being removably attached or permanently attached.

19. The method for interactive storytelling of claim 18, further comprising:
introducing at least one new spider relating to the story on one or more pages of the book;
attaching flies relating to the story to the at least one new spider;
removing a boot from the spider;
attaching a fly to the spider; and
manipulating all the elements relating to the story to respective original positions.

20. The method for interactive storytelling of claim 19, further comprising manipulating a fly to a spider using a handheld magnetic member.
